(19) United States
(12) Patent Application Publication
(10) Pub. No.: US 2025/0093484 A1
(43) Pub. Date: Mar. 20, 2025

(54) INFORMATION PROCESSING APPARATUS, SYSTEM, METHOD AND STORAGE MEDIUM

(71) Applicant: KABUSHIKI KAISHA TOSHIBA, Tokyo (JP)

(72) Inventor: Ryota SEKIYA, Kamakura Kanagawa (JP)

(73) Assignee: KABUSHIKI KAISHA TOSHIBA, Tokyo (JP)

(21) Appl. No.: 18/626,492

(22) Filed: Apr. 4, 2024

(30) Foreign Application Priority Data
Sep. 14, 2023 (JP) 2023-149061

(51) Int. Cl. G01S 13/04; G01S 13/90

(52) U.S. Cl. CPC G01S 13/04; G01S 13/9021

(57) ABSTRACT

According to one embodiment, an information processing apparatus includes a processor. The processor is configured to acquire a first observation signal from a radar device with a plurality of antennas configured to transmit a radar signal and to receive a radar echo based on a reflected wave of the radar signal, generate a first radar image by executing a signal process based on a predetermined first condition, and generate a second radar image by executing a signal process based on a second condition. The first and second radar images are used as training data for a learning model to detect an object to which the radar signal is transmitted.

### CROSS-REFERENCE TO RELATED APPLICATIONS

This application is based upon and claims the benefit of priority from Japanese Patent Application No. 2023-149061, filed Sep. 14, 2023, the entire contents of which are incorporated herein by reference.

### FIELD

Embodiments described herein relate generally to an information processing apparatus, system, method, and a storage medium.

### BACKGROUND

In recent years, a radar system that images an object by using a reflected wave of a radar signal (transmission wave) (that is, a radar system that generates a radar image including the object) has been developed.

Here, detection (identification) of an object in a radar image generated in the aforementioned radar system using a prepared machine learning model (radar sensing AI) has been considered.

Machine learning is the framework that automatically discovers the representations needed for feature detection or classification from training dataset (pairs of the radar images and label information indicatives of the object in the radar images). In order to obtain the machine learning model with higher detection or classification capability (accuracy), the richness of the training dataset is required. In other words, if the number of training data (especially, radar images) is small, achieving the model with high accuracy is difficult, and thus, a mechanism to increase variations and the number of training data (augmentation) is demanded.

### BRIEF DESCRIPTION OF THE DRAWINGS

FIG. 1 is a diagram for explaining an outline of a FMCW method implemented in a radar device.

FIG. 2 is a diagram for explaining an outline of a MIMO radar.

FIG. 3 is a diagram for explaining an outline of a synthetic aperture process.

FIG. 4 is a diagram for explaining an outline of the synthetic aperture process.

FIG. 5 is a diagram for explaining an outline of the synthetic aperture process.

FIG. 6 is a diagram for explaining an example of a structure of a radar system of an embodiment.

FIG. 7 is a diagram for explaining an example of a hardware structure of an information process.

FIG. 8 is a flowchart of an example of a process procedure of the information processing apparatus.

FIG. 9 is a diagram for explaining observation points realized by a combination of a plurality of transmitter antennas and a plurality of receiver antennas.

FIG. 10 is a diagram for explaining a synthetic aperture process executed by a signal processing module.

FIG. 11 is a diagram for explaining an outline of a mixing process.

FIG. 12 is a diagram for explaining noise addition of a radar image.

FIG. 13 is a diagram for explaining dynamic range of a radar image.

FIG. 14 is a diagram for explaining shifting, reversal, rotation, enlargement, and reduction of a radar image.

FIG. 15 is a diagram for explaining shifting in a radar image recreated by selecting antennas.

FIG. 16 is a diagram for explaining an example of first and second radar images generated in the embodiment.

### DETAILED DESCRIPTION

In general, according to one embodiment, an information processing apparatus includes a processor. The processor is configured to acquire a first observation signal from a radar device with a plurality of antennas configured to transmit a radar signal and to receive a radar echo based on a reflected wave of the radar signal, the first observation signal being based on the radar signal and the radar echo, generate a first radar image by executing a signal process based on a predetermined first condition, with respect to the first observation signal, and generate a second radar image by executing a signal process based on a second condition which is different from the first condition, with respect to the first observation signal. The first and second radar images are used as training data for a learning model to detect an object to which the radar signal is transmitted.

Various embodiments will be described with reference to the accompanying drawings.

A radar system according to the present embodiment is configured to measure an azimuth in which an object is positioned and a distance to the object by using a reflected wave, from the object, of a radar signal transmitted (emitted) to the object, and image the object (generate a radar image including the object). Note that the radar signal transmitted to the object in such a radar system is, for example, a radio wave such as a millimeter wave (extra high frequency (EHF)).

Hereinafter, an outline of the radar system will be briefly described. First, a frequency modulated continuous wave (FMCW) method will be described as an example of a radar modulation method for performing frequency modulation.

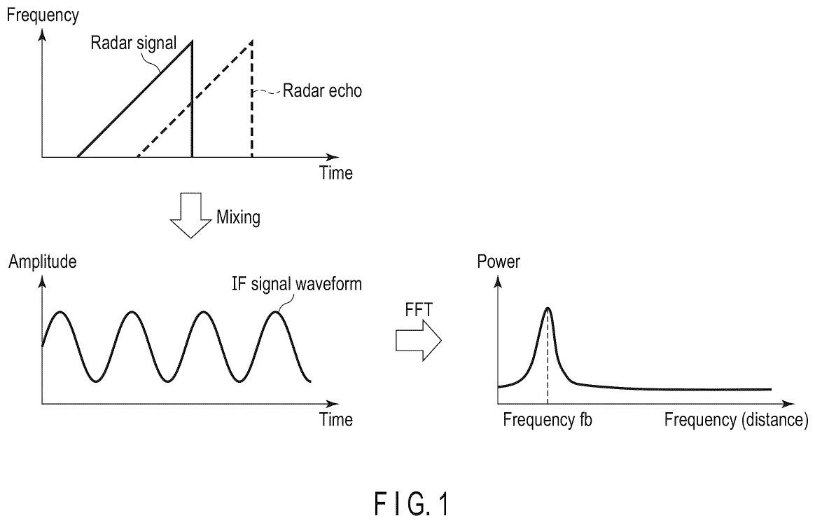

According to the FMCW method, as illustrated in FIG. 1, a radar signal (transmitted wave) modulated in such a way that a frequency changes with the lapse of time is transmitted, and a distance to an object is measured based on a frequency difference (hereinafter, referred to as a beat frequency) between the radar signal and a radar echo (reflected wave signal) based on a reflected wave of the radar signal.

Specifically, in the FMCW method, an intermediate frequency (IF) signal (hereinafter, referred to as an IF signal) is acquired by mixing the radar signal and the radar echo. The IF signal corresponds to a time waveform (sine wave) of the beat frequency described above. f_{b}, γ, and τ have a relationship of f_{b}=γ_{τ}, in which f_{b} represents the beat frequency, γ is an inclination (frequency change rate) (Hz/s) of the radar signal called a chirp rate, and τ represents a round trip time with respect to the radar signal.

When, for example, fast Fourier transform (FFT) is applied to the IF signal, the IF signal is converted into frequency domain representation. In the FFT result, a peak appears at a position of the beat frequency fb, and a distance (that is, the distance to the object reflecting the radar signal) corresponding to a position of the peak can be obtained.

The FMCW method that linearly performs frequency modulation as illustrated in FIG. 1 is particularly referred to as linear-FMCW.

Here, the radar system includes a radar device including a transmitter antenna (transmission antenna) and a receiver antenna (reception antenna), and a multiple-input multiple-output (MIMO) radar can be used as the radar device. The MIMO radar includes a plurality of transmitter antennas (transmitter antenna array) and a plurality of receiver antennas (receiver antenna array), and each of the transmitter antennas transmits a radar signal in a time division manner, and a radar echo based on a reflected wave of the radar signal is received by the plurality of receiver antennas, so that it is possible to implement a large number of times of reception of the radar echo (that is, radar observation) with a small number of times of transmission of the radar signal (that is, the number of times of radar emission).

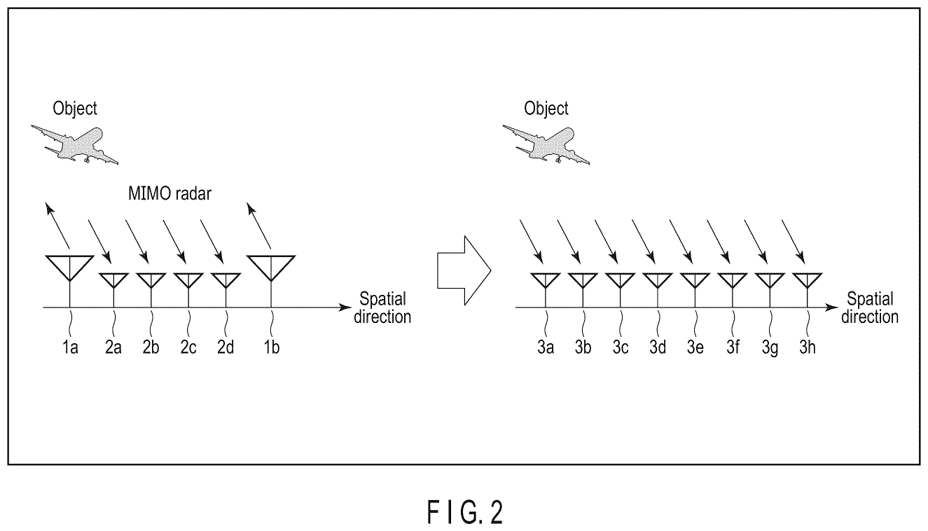

Specifically, as illustrated in FIG. 2, it is assumed that the MIMO radar includes, for example, two transmitter antennas 1a and 1b and four receiver antennas 2a to 2d linearly arranged in a predetermined spatial direction.

In this case, for example, assuming that a radar signal is transmitted from the transmitter antenna 1a, a radar echo based on a reflected wave of the radar signal is received by the receiver antenna 2a. Although the receiver antenna 2a has been described here, the radar echo based on the reflected wave of the radar signal transmitted from the transmitter antenna 1a is similarly received by the receiver antennas 2b to 2d.

Similarly, for example, assuming that a radar signal is transmitted from the transmitter antenna 1b, a radar echo based on a reflected wave of the radar signal is received by the receiver antenna 2a. Although the receiver antenna 2a has been described here, the radar echo based on the reflected wave of the radar signal transmitted from the transmitter antenna 1b is similarly received by the receiver antennas 2b to 2d.

That is, in the MIMO radar described above, radar observation is performed in each of the receiver antennas 2a to 2d when a radar signal is transmitted from the transmitter antenna 1a, and radar observation is similarly performed in the receiver antennas 2a to 2d when a radar signal is transmitted from the transmitter antenna 1b.

With this configuration, the MIMO radar including the two transmitter antennas 1a and 1b and the four receiver antennas 2a to 2d as illustrated in FIG. 2 can implement eight observation points 3a to 3h arranged in the spatial direction only by emitting the radar signal from each of the transmitter antennas 1a and 1b once. For example, the observation point 3a is an observation point implemented by the receiver antenna 2a receiving a radar echo based on a reflected wave of the radar signal transmitted from the transmitter antenna 1a. Similarly, the observation points 3b to 3d are observation points implemented by the receiver antennas 2b to 2d receiving radar echoes based on reflected waves of the radar signals transmitted from the transmitter antenna 1a.

Furthermore, the observation point 3e is an observation point implemented by the receiver antenna 2a receiving a radar echo based on a reflected wave of the radar signal transmitted from the transmitter antenna 1b. Similarly, the observation points 3f to 3h are observation points implemented by the receiver antennas 2b to 2d receiving radar echoes based on reflected waves of the radar signals transmitted from the transmitter antenna 1b. That is, in the MIMO radar, one observation point is implemented by a combination of one transmitter antenna and one receiver antenna.

With such a MIMO radar, it is possible to measure a distance to an object by using an observation signal (an IF signal acquired based on radar signals transmitted from the transmitter antennas 1a and 1b in a time division manner and a radar echo received by each of the receiver antennas 2a to 2d) observed at each of the observation points 3a to 3h.

Note that, the above-described MIMO radar is used as a radar device in the present embodiment; however, the radar device may be a single-input single-output (SISO) radar with a single antenna to transmit a radar signal and to receive a radar echo.

By the way, in the radar system of the present embodiment, it is possible to perform imaging of the object (generation of radar image) using an observation signal acquired from the above-described radar device, and it is desired that spatial resolution is improved in imaging of the object.

In a case where the MIMO radar is used as above, observation signal is acquired in each observation point implemented per pair of a transmitter antenna and a receiver antenna, and, in the present embodiment, the spatial resolution can be improved by executing a synthetic aperture process in which observation signals acquired in each observation point are synthesized.

Note that, the synthetic aperture process corresponds to a signal process performed in a synthetic aperture radar (SAR). In general, when an antenna aperture length increases, spatial resolution increases, and the synthetic aperture process is a signal process to perform, for example, observation for multiple times while moving a small aperture antenna with low resolution, and to synthesize the observation results to virtually realize high resolution imaging obtained through a large aperture antenna.

Hereinafter, an outline of the synthetic aperture process will be explained. The synthetic aperture process includes two steps; extraction of echo components and calculation of convolution integral.

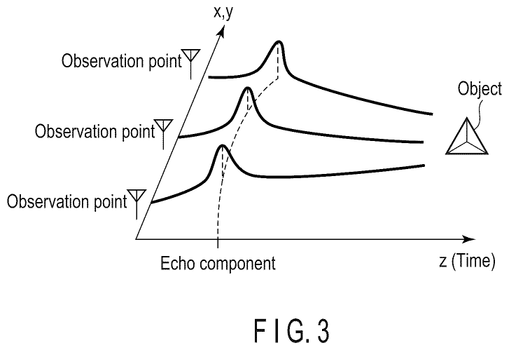

Initially, extraction of echo components means measurement with respect to an object as in FIG. 3. Specifically, when FFT is applied to an observation signal (IF signal) in the aforementioned FMCW method, a power peak appears in a distance where the object exists in a result of the FFT (range peak). This is echo component, and may be referred to as range compression echo signal. Note that the echo component is extracted per observation point.

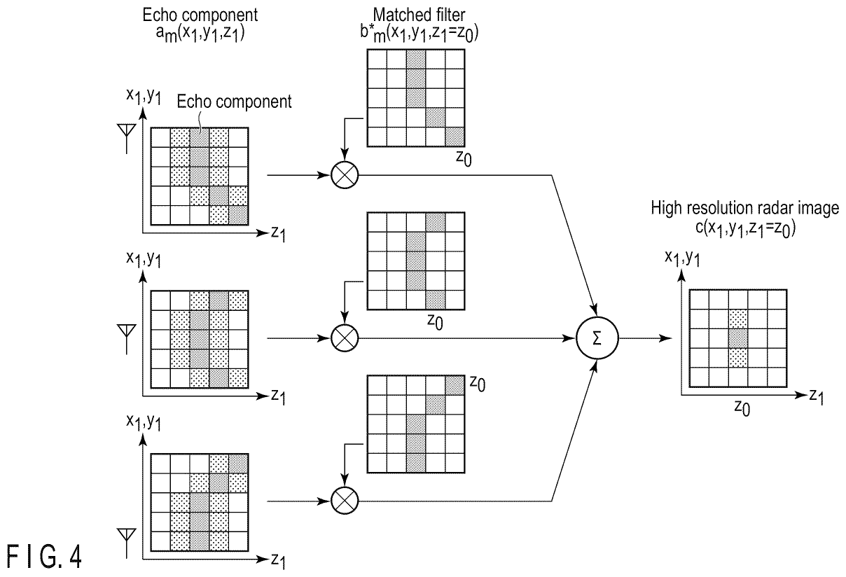

Now, the convolution integral means that, as in FIG. 4, convolution integral between the echo components extracted per observation point and the matched filter is calculated. The radar image is generated through calculation of the convolution integral.

Specifically, when the echo component is a (x_{I}, y_{I}, z_{I}) and the matched filter is b (x_{I}, y_{I}, z_{I}), C (x_{I}, y_{I}, z_{I}) which is the high resolution radar image will be generated the following equation (1).

$$c ( {x}_{I} , {y}_{I} , {z}_{I} ) = {\sum }_{m ∈ N} {a}_{m} ( {x}_{I} , {y}_{I} , {z}_{I} ) {b}_{m}^{*} ( {x}_{I} , {y}_{I} , {z}_{I} ) \qquad Equation 1$$

Note that, N is a set of observation points, and m is the observation point in set N. x_{I}, y_{I}, and z_{I} represent pixels (spatial coordinates) in width, height, and depth of the radar image generated by the synthetic aperture process, respectively. b* is complex conjugate of the matched filter b.

Here, the spatial resolution is changed by not only the antenna aperture length but also a distance to the object positioned in an emission direction of the radar signal (that is, object reflecting the radar signal). When generating a high resolution radar image at distance z₀ in the synthetic aperture process, convolution integral of the echo components extracted per observation point and matched filter (z₀) is calculated. Specifically, the matched filter extracting component of distance z₀ is multiplied with each echo component, and a sum thereof is calculated. That is, a distance to generate the high resolution radar image has been set in the matched filter used in the synthetic aperture process.

As described above, echo components (echo signals) extracted per observation point have a minute delay time according to transmitter/receiver antenna and the object, and thus, high resolution in the radar image can be achieved by calculating convolution.

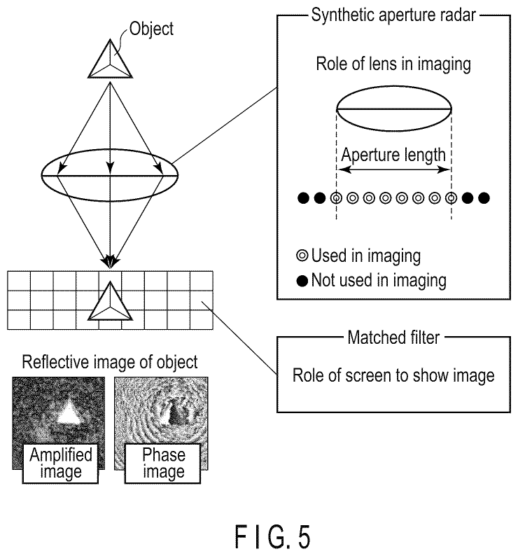

Note that, as in FIG. 5, many observation signals are gathered by the aforementioned synthetic aperture process (synthetic aperture radar) for imaging, and thus, it is similar to imaging by an optical image lens. In that case, a lens size corresponds to an aperture length of a virtual large aperture antenna obtained by the synthetic aperture process, and a screen showing an image corresponds to the matched filter.

Note that, in the present embodiment, a radar image is generated by executing the synthetic aperture process with respect to an observation signal acquired by the radar device, and for example, an object included in the radar image is detected (object identification is performed) by using a machine learning model corresponding to a radar sensing AI, for example.

Specifically, if the radar system according to the present embodiment is applied to a security inspection system installed in a facility such as an airport, a station, a shopping mall, a concert hall, or an exhibition hall, whether or not a target of inspection moving in the proximity of the radar device possesses a predetermined object (for example, dangerous article) can be detected using the machine learning model.

The aforementioned machine learning model is obtained by learning training data included in a pair of a radar image and label information representing the radar image (object therein). The machine learning model which has learnt the training data is structured such that, when a radar image is input, the label information representing an object included in the radar image is output. The label information output from the machine learning model (object represented thereby) corresponds to a detection result.

Note that, the machine learning model is composed of the framework, such that, machine learning or deep learning. Specifically, the machine learning model may be obtained by applying various machine learning algorithms such as neural network or random forest.

Here, in order to improve accuracy in detection in the machine learning model, the large amount of datasets must be fed to the machine learning model; however, preparation of such datasets (specifically, radar images) is difficult. In general, an augmentation technique of optical images may be applied in order to prepare the large amount of datasets in the present embodiment; however, for example, characteristics between radar images (wavelength) generated by a signal process using observation signals as information of complex number representing amplitude and phase and general images (optical) are greatly different, and thus, if the augmentation technique of optical images is simply applied, variation of augmented dataset, which suitably represents a class distribution of the radar images, cannot be achieved.

Therefore, in the present embodiment, an augmentation technique to generate the large amount of datasets representing radar image likeness in a process of signal processing to generate a radar image (that is, radar image augmentation technique) which is different from the augmentation technique of optical images will be proposed.

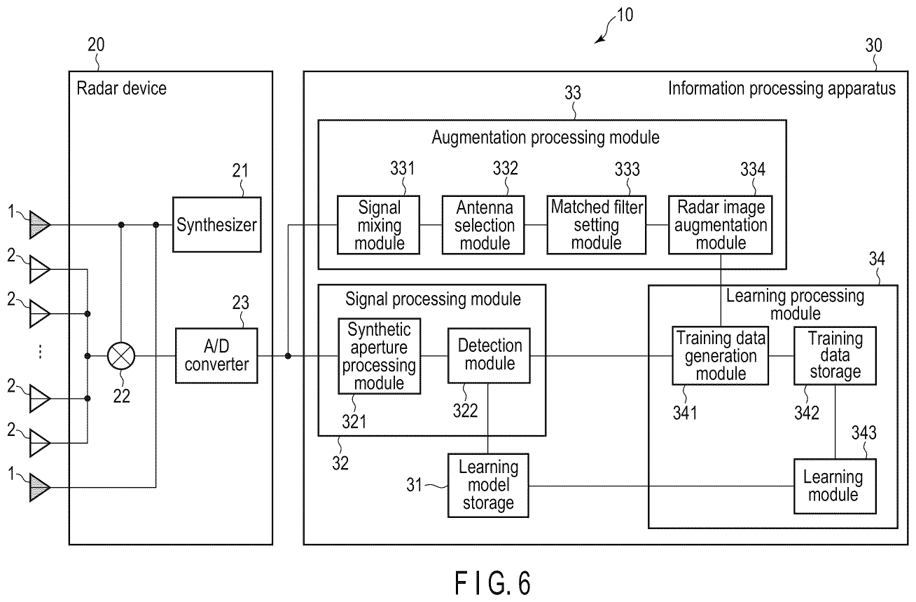

Here, the radar system of the present embodiment will be described. FIG. 6 illustrates an example of the structure of the radar system. As in FIG. 6, a radar system 10 includes a radar device 20 and an information processing apparatus 30 communicably connected to the radar device 20.

The radar device 20 is a MIMO radar adopting an FMCW method, and includes, for example, a plurality of transmitter antennas 1 and a plurality of receiver antennas 2. Furthermore, the radar device 20 includes a synthesizer 21, mixer 22, and A/D converter 23.

The synthesizer 21 generates a radar signal based on the FMCW method (transmitter wave to which modulation has been applied such that frequency changes according to a time lapse). The radar signal generated by the synthesizer 21 is output to the transmitter antennas 1 and the mixer 22.

Each of the transmitter antennas 1 transmits (emits) the radar signal output from the synthesizer 21 in a time division manner. Furthermore, each of the receiver antennas 2 receives radar echo based on a reflective wave of the radar signal transmitted from each of the transmitter antennas 1. The radar echo received by the receiver antennas 2 is output to the mixer 22.

The mixer 22 mixes the radar signal output from the synthesizer 21 and the radar echo output from the receiver antennas 2. Through such mixing by the mixer 22, the aforementioned IF signal is generated (acquired).

Note that, if the radar device 20 includes the transmitter antennas 1a and 1b and the receiver antennas 2a to 2d as in FIG. 2, the IF signal is generated per observation points 3a to 3h (that is, combinations of the transmitter antennas 1a and 1b and the receiver antennas 2a to 2d). The IF signal generated by the mixer 22 is output to the A/D converter 23.

The A/D converter 23 performs analogue-to-digital conversion of the IF signal output from the mixer 22 (that is, performs A/D conversion with respect to the IF signal) to generate (acquire) an observation signal. The observation signal generated by the A/D converter 23 corresponds to the observation signal observed in each of the observation points 3a to 3h, and is output (transmitted) to the information processing apparatus 30.

As in FIG. 6, the information processing apparatus 30 includes a machine learning model storage 31, signal processing module 32, augmentation processing module 33, and learning processing module 34.

The machine learning model storage 31 a machine learning model structured to input the radar image and output label information representing an object included in the radar image (that is, machine learning model to detect an object to which a radar signal is transmitted).

The signal processing module 32 includes synthetic aperture processing module 321 and detection module 322. The synthetic aperture processer 321 acquires an observation signal output from the radar device 20 (A/D converter 23), and executes the synthetic aperture process with respect to the observation signal to generate a radar image (hereinafter, represented as a first radar image). The first radar image generated by the synthetic aperture processing module 321 is output to the detection module 322.

The detection module 32 uses the machine learning model retained in the machine learning model storage 31 to detect an object included in the first radar image output from the synthetic aperture processing module 321. Specifically, the detection module 322 inputs the first radar image output from the synthetic aperture processing module 321 to the machine learning model to acquire label information output from the machine learning model. The label information acquired as above corresponds to information representing the object detected (estimated) by the machine learning model (that is, detection result). The first radar image output from the synthetic aperture processing module 321 and the label information acquired by the detection module 322 are output to the learning processing module 34.

Here, the above-described synthetic aperture processing module 321 is assumed to perform the synthetic aperture process (radar signal process) based on a predetermined first condition. In that case, the augmentation processing module 33 acquires the observation signal output from the radar device 20 (A/D converter) while changing the first condition to acquire a second condition which is different from the first condition. The augmentation processing module 33 executes the synthetic aperture process (radar signal process) with respect to the observation signal based on the second condition to realize augmentation of the radar image. Note that, in the following description, the radar image generated by the augmentation processing module 33 (that is, augmented radar image) will be referred to as second radar image for convenience of description.

The augmentation processing module 33 includes a signal mixing module 331, antenna selection module 332, matched filter setting module 333, and radar image augmentation module 334.

To the observation signal acquired from the radar device, the signal mixing module 331 adds a different observation signal acquired in a time of acquisition of the observation signal to generate a synthetic signal.

Furthermore, the observation signal acquired from the radar device 20 is a signal observed in an observation point realized per combination of the transmitter antenna 1 and the receiver antenna 2, for example, and the antenna selection module 332 selects a part of combinations of the transmitter antennas 1 and the receiver antennas 2 (that is, some antennas of the antennas), and acquires observation signals observed in observation points realized by the selected combinations. In other words, the antenna selection module 332 acquires a part of the observation signals output from the radar device 20.

The matched filter setting module 333 sets (generates) a matched filter used in convolution integral calculation of the echo components of combinations of the selected antennas performed in the synthetic aperture process.

The radar image augmentation module 334 generates a second radar image by executing the synthetic aperture process using the synthetic signal generated by the signal mixing module 331.

That is, if the first condition includes setting the target of the synthetic aperture process to be observation signal acquired from the radar device 20, the signal mixing module 331 may be considered as a function module to change the first condition to a second condition which sets the target of the synthetic aperture process to be synthetic signal generated by the signal mixing module 331.

Furthermore, the radar image augmentation module 334 generates a second radar image by executing the synthetic aperture process using the observation signal acquired by the antenna selection module 332.

Here, assuming that the first condition includes setting the target of the synthetic aperture process to be observation signal acquired by the radar device 20, the antenna selection module 332 may be considered as a function module which changes the first condition to the second condition which sets the target of the synthetic aperture process to be the observation signal acquired by the antenna selection module 332 (that is, some of the observation signal acquired from the radar device 20). In other words, the antenna selection module 332 has a function to estimate a pattern of antenna combinations which is different from the observation signal used by the signal processing module 32 (synthetic aperture processing module 321).

Furthermore, the radar image augmentation module 334 uses the matched filter set by the matched filter setting module 333 when executing the synthetic aperture process. Thereby, the radar image augmentation module 334 generates a second radar image by calculating convolution integral of the observation signal acquired from the radar device 20 and the matched filter set by the matched filter setting module 333.

Here, assuming that the first condition includes using the prepared matched filter (hereinafter, will be referred to as first matched filter) in the synthetic aperture process as described above, the matched filter setting module 333 may be considered as a function module which changes the first condition to a second condition using a matched filter which is different from the first matched filter (hereinafter will be referred to as second matched filter). In other words, the matched filter setting module 333 has a function which estimates a pattern of the second matched filter with a condition different from that of the first matched filter used by the signal processing module 32 (synthetic aperture processing module 321).

That is, the above-described signal mixing module 331, antenna selection module 332, and matched filter setting module 333 functions as a condition changing module configured to change conditions related to the synthetic aperture process, and in the radar image augmentation module 334, the second radar image is generated under a condition which is different from the signal processing module 32.

The second radar image generated by the radar image augmentation module 334 (radar image augmented by the first radar image) is output to the learning processing module 34.

The learning processing module 34 includes a training data generation module 341, training data storage 342, and learning module 343.

The training data generation module 341 generates training data by processing the second radar image and label information output from the signal processing module 32 (detection module 322). Furthermore, the training data generation module 341 processes the second radar image output from the augmentation processing module 33 (radar image augmentation module 334) and the label information output from the signal processing module 32 to generate the training data. In that case, the training data generation module 341 generates the first radar image to which the label information is added (that is, pair of the first radar image and the label information) and the second radar image to which the label information is added (that is, pair of the second radar image and the label information) as training data, respectively. The training data generated by the training data generation module 341 are stored in the training data storage 342.

The learning module 343 uses the training data stored in the training data storage 342 to perform learning the machine learning model retained in the machine learning model storage 31.

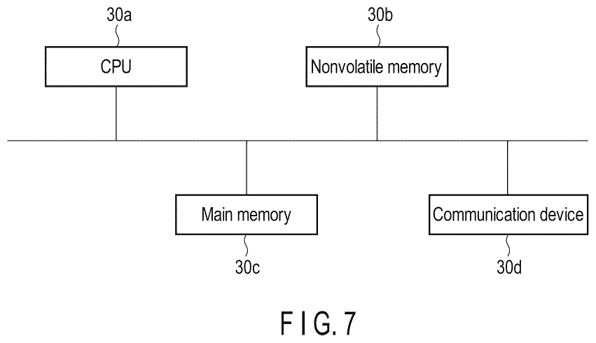

FIG. 7 illustrates an example of a hardware structure of the information processing apparatus 30 of FIG. 3. As in FIG. 7, the information processing apparatus 30 includes a CPU 30a, nonvolatile memory 30b, main memory 30c, and communication device 30d.

The CPU 30a is a processor configured to control operations of various components of the information processing apparatus 30. The CPU 30a may be a single processor, or may be configured with a plurality of processors. The CPU 30a executes various programs loaded from the nonvolatile memory 30b to the main memory 30c. The communication device 30d is a device configured to execute wireless or wired communication.

In FIG. 7, only the nonvolatile memory 30b and the main memory 30c are illustrated; however, the information processing apparatus 30 may include other memory devices such as hard disk drive (HDD) and solid state drive (SSD). Furthermore, the information processing apparatus 30 may further includes an input device (mouse, keyboard, and the like) and a display device (display and the like).

Note that, in the present embodiment, a part or all of the signal processing module 32, augmentation processing module 33, and learning processing module 34 (training data generation module 341 and the learning module 343) may be realized by causing the CPU 30a (that is, computer of the information processing apparatus 30) to execute a predetermined program, that is, by software. The program may be stored in a computer readable memory medium for distribution, or may be downloaded to the information processing apparatus 30 through the network.

In this example, it has been explained that a part or all of the signal processing module 32, augmentation processing module 33, and learning processing module 34 of FIG. 6 are realized by software; however, a part or all of the signal processing module 32, augmentation processing module 33, and learning processing module 34 may be realized by an integrated circuit (IC), or may be realized by a combination of software and hardware.

Furthermore, the training data storage 342 included in the machine learning model storage 31 and the learning processing module 34 may be realized by, for example, the nonvolatile memory 30b or other memory devices.

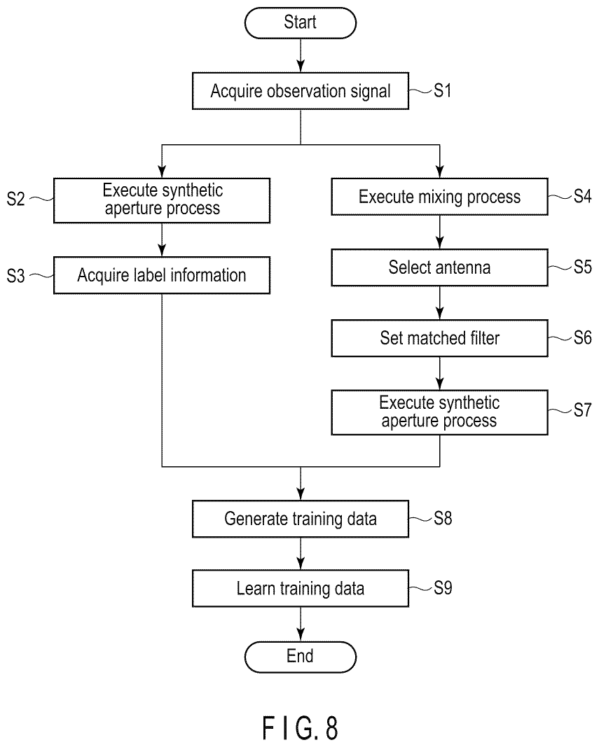

Hereinafter, an example of a process procedure of the information processing apparatus 30 of the present embodiment will be explained with reference to flowchart of FIG. 8.

As described above, the radar device 20 transmits a radar signal from each of the transmitter antennas 1, and receives radar echo based on reflective wave of the radar signal in each of the receiver antennas 2 to output an observation signal.

In that case, the information processing apparatus 30 (signal processing module 32 and augmentation processing module 33) acquires the observation signal output from the radar device 20 (step S1).

Upon execution of the process of step S1, the signal processing module 32 executes processes of steps S2 and S3.

Initially, the synthetic aperture processing module 321 included in the signal processing module 32 executes a synthetic aperture process using the observation signal acquired in step S1 (step S2). In step S2, the synthetic aperture processing module 321 executes the synthetic aperture process based on the first condition, for example.

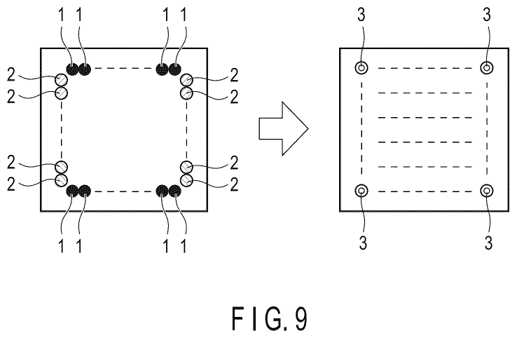

Here, if the radar device 20 includes a plurality of transmitter antennas 1 and a plurality of receiver antennas 2 arranged in the left side of FIG. 9 (antenna module configured thereby), the radar device 20 can output an observation signal observed in each observation point 3 arranged on a matrix as illustrated in the right side of FIG. 9.

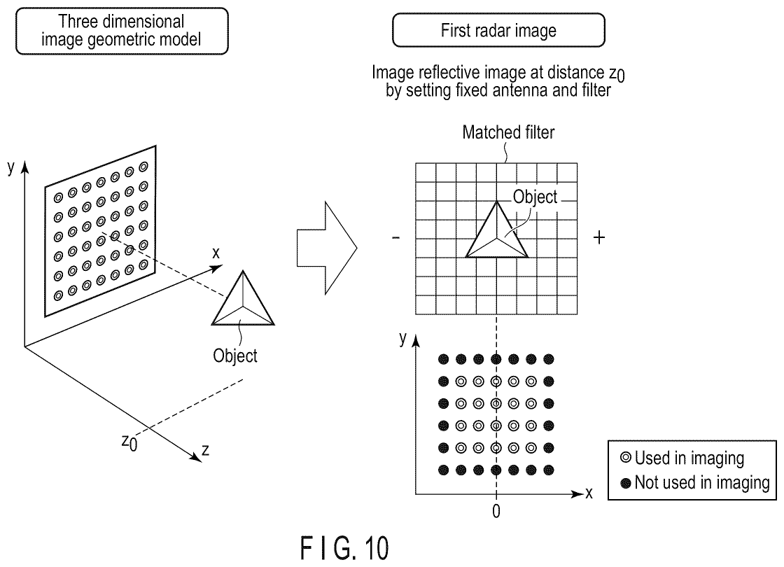

In that case, assuming that the observation point 3 is realized per combination of the transmitter antenna 1 and the receiver antenna 2 as above, in step S2, a process to adopt a predetermined combination of transmitter antenna and receiver antenna and setting of the matched filter as in FIG. 10 and to image a reflective image at distance z₀. In other words, in step S2, the synthetic aperture process using a fixed antennas and setting of the matched filter as a first condition is executed.

Note that, in FIG. 10, it is assumed that observation points are arranged on a matrix of six by seven, for example. Furthermore, in FIG. 10, it is assumed that some observation signals acquired in all observation points realized by the transmitter antennas 1 and the receiver antennas 2 are used; however, all of the observation signals may be used.

The synthetic aperture processing module 321 executes the process of step S2 (that is, synthetic aperture process based on the first condition) to generate a first radar image including an object.

Then, the detection module 322 inputs the first radar image generated by the synthetic aperture processing module 321 to the machine learning model retained in the machine learning model storage 31 to acquire the label information output from the machine learning model (label information representing the object included in the first radar image) (step S3).

In this example, the processes of steps S2 and S3 executed by the signal processing module 32 have been explained; however, when the above-described process of step S1 is executed, the augmentation processing module 33 executes the processes of steps S4 to S7.

Initially, to the observation signal acquired in step S1, the signal mixing module 331 included in the augmentation processing module 33 executes adding an observation signal which is different from the observation signal (hereinafter will be referred to as mixing process) (step S4).

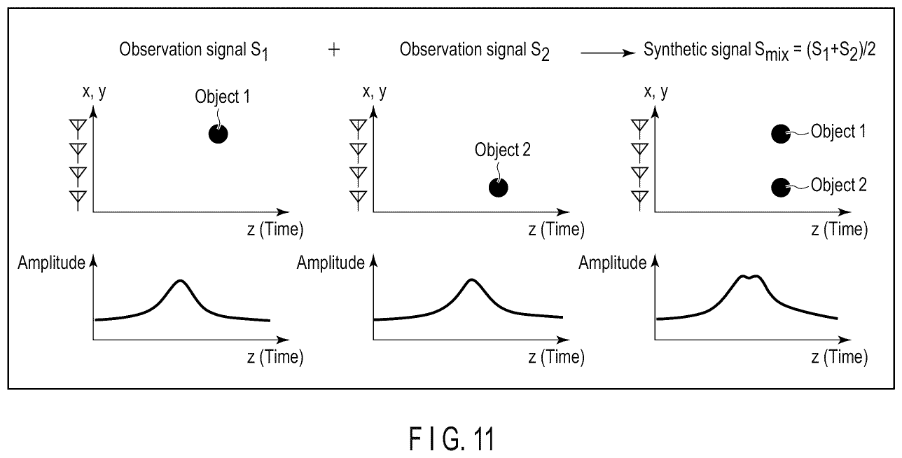

Specifically, as in FIG. 11, given that the observation signal acquired in step S1 is s₁, and the different observation signal acquired at a different time than the observation signal s₁ is s₂, in step S4, synthetic signal sₘᵢₓ=(s₁+s₂)/2 is generated as the observation signal used to generate the second radar image (that is, target for the synthetic aperture process). Note that the observation signal s₂ added to the observation signal s₁ may be preliminarily retained in the signal mixing module 331, or may be acquired from the outside of the information processing apparatus 30.

Next, the antenna selection module 332 selects some of the transmitter antennas and the receiver antennas of the radar device 20 (step S5). The antenna selection module 332 acquires the observation signal observed in the observation points realized by the selected antennas (combination of transmitter antennas 1 and receiver antennas 2) as observation signals used for generating the second radar image (that is, target of the synthetic aperture process). Note that, the antennas selected in step S5 are at least partly different from the antennas (combination thereof) realizing the observation signals used in the above-described synthetic aperture process of step S2.

Furthermore, the matched filter setting module 333 sets the second matched filter used to generate the second radar image (step S6). Note that, the setting of the second matched filter in step S6 is at least partly different from the setting of the first matched filter used in the above-described synthetic aperture process of step S2.

When the above-described processes of steps S4 to S6 are executed, the radar image augmentation module 334 executes the synthetic aperture process based on process results of steps S4 to S6 (step S7).

Specifically, for example, the synthetic aperture process is executed targeting the observation signal acquired form the radar device 20 in step S2; however, in step S7, the synthetic aperture process is executed targeting the synthetic signal generated in step S4.

Furthermore, for example, in step 2, the synthetic aperture process is executed targeting the observation signal acquired from the radar device 20; however, in step S7, the synthetic aperture process is executed targeting the observation signal observed in the observation point realized by the antennas selected in step S5 (some of the observation signals acquired from the radar device 20).

Furthermore, in step S2, the synthetic aperture process is executed using the fixed first matched filter; however, in step S7, the synthetic aperture process is executed using the second matched filter set in step S6.

That is, in step S7, unlike step S2, the synthetic aperture process is executed based on the second condition with a changed target of the synthetic aperture process and changed setting of the matched filter.

The radar image augmentation module 334 executes the process of step S7 to generate the second radar image including an object.

Note that, in the synthetic aperture process of step S2, one radar image alone is generated with the observation signal acquired from the radar device 20 (that is, one time radar measurement by the radar device 20) while, in the present embodiment, the synthetic aperture process is executed based on the process results of steps S4 to S6, and thus, the second radar images of the number of (with/without mixing process)×(number of patterns of selected antennas)×(number of patterns of setting of matched filter) can be generated.

In this example, it has been explained that the synthetic aperture process is executed based on the process results of steps S4 to S6 (that is, second radar image is generated); however, in the present embodiment, the processes of steps S4 to S6 may be omitted as long as a sufficient number of second radar images can be generated.

Here, in the present embodiment, the aforementioned processes of steps S4 to S7 are executed to generate a second radar image recreating a general optical image augmentation technique such as noise addition, brightness/contrast adjustment, shifting, reversal, enlargement, reduction, and mixing through a radar signal process. Hereinafter, the second radar image generated in the present embodiment will be explained.

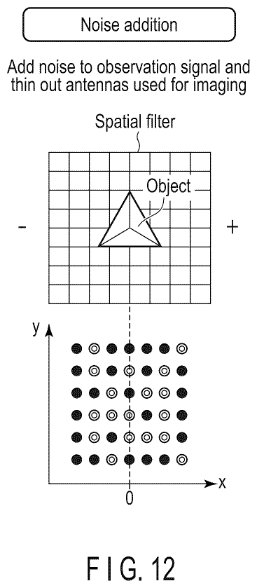

In an augmentation technique of an optical image, noise addition is performed by adding Gauss noise to the image. In contrast, to recreate noise addition in a radar image, a signal-to-noise ratio (SNR) of the radar image shall be deteriorated. Specifically, in a case where a first radar image is generated using the observation signal observed in the observation point indicated in the right side of FIG. 10, as in FIG. 12, only some of the observation points (a plurality of antennas realizing thereof) are selected and the number of the observation points is reduced (that is, number of observation signals used in the synthetic aperture process is thinned out), and thus, the second radar image with deteriorated SNR of the first radar image can be generated.

Note that, in the synthetic aperture process, a large number of observation signals are integrated by convolution of echo components and matched filters. In that case, when the number of observation signals to be integrated, SNR is improved, and thus, SNR of the radar images can be deteriorated without using some observation signals (antennas).

In the second radar image where SNR is deteriorated as above (that is, second radar image which is first radar image with noise added), power difference between the image of the object and background noise becomes small, and as compared to the first radar image, the background noise can be visible.

That is, in the present embodiment, as a condition where the synthetic aperture process is executed, the observation signal which is a target of the synthetic aperture process (that is, observation points or antennas realizing the observation points) is changed to generate the second radar image which is different from the first radar image.

Note that the second radar image may be generated by adding complex number noise with respect to the observation signal or the first radar image.

Furthermore, in this example, a case where noise is added (SNR is deteriorated) has been explained; however, a second radar image which is a first radar image with improved SNR may be generated. Specifically, if the synthetic aperture process is executed using more observation signals, the second radar image which is the first radar image with improved SNR can be generated. Furthermore, when the second radar image is generated using the observation signal, a signal process to improve SNR (signal processing technique to realize noise suppression or side lobe suppression) may be applied.

Note that, the second radar image may be generated by adjusting (changing) brightness or contrast of the first radar image.

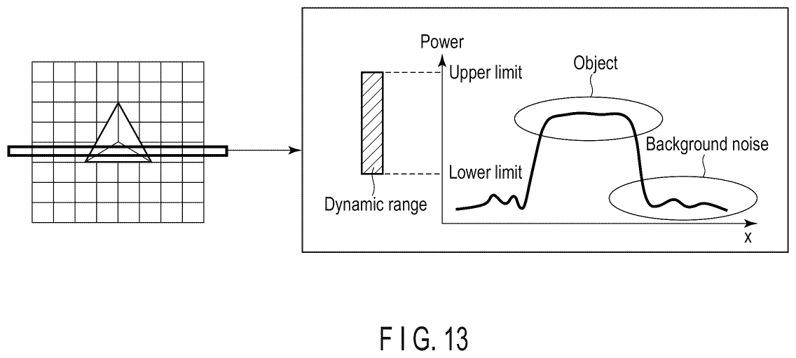

From the standpoint of changing the brightness or contrast of the first radar image, a second radar image may be generated with a dynamic range which is different from that of a first radar image. Dynamic range corresponds to, as in FIG. 13, a range between the maximum power (upper limit) and the minimum power (lower limit) of observation signals by which an object becomes visible in the radar image. By adjusting the dynamic range with respect to the object in the observation signal and the power of the background noise, brightness and contrast of the radar image can be changed. For example, if the maximum power of the dynamic range is higher than the power of the object, a radar image including an object which is visible in a relatively dark state will be generated. Furthermore, if the minimum power of the dynamic range is higher than the power of the background noise, a radar image in which the noise is not visible will be generated. Furthermore, if the minimum power of the dynamic range is lower than the power of the background noise, a radar image with increased background noise will be generated.

In the present embodiment, as a condition when the synthetic aperture process is executed, the second radar image which is different from the first radar image may be generated by changing the dynamic range as described above.

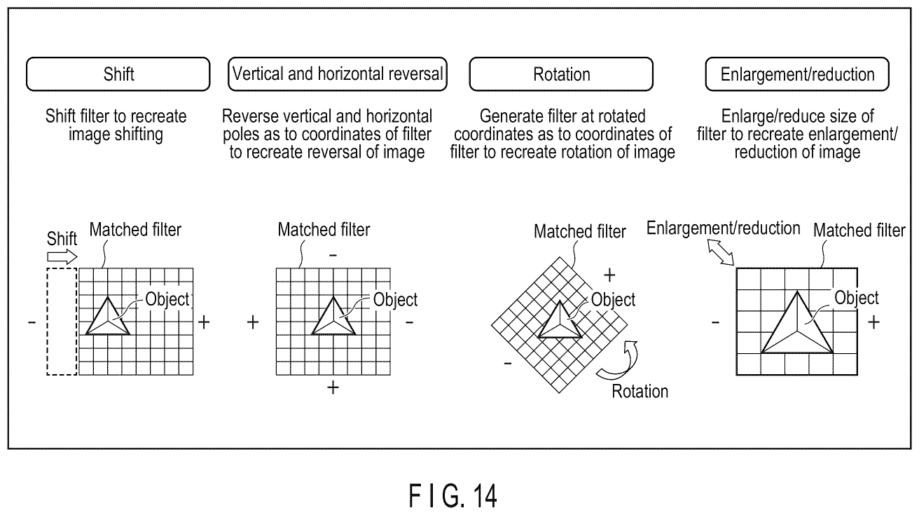

Furthermore, since the matched filter corresponds to a screen to show an image as described above, and thus, in a case where shifting, reversal, rotation, enlargement, and reduction are recreated in the radar image, as in FIG. 14, the radar signal process (synthetic aperture process) is executed while the matched filter is shifted, reversed, rotated, enlarged, and reduced.

Specifically, the radar image is generated by calculating convolution integral of echo components extracted from the observation signals in the synthetic aperture process and the matched filter, and shifting of the radar image is recreated by shifting coordinates of the matched filter (screen).

Reversal of the radar image is recreated by reversing vertical and horizontal poles as to the coordinates of the matched filter. Note that, in the reversal of the radar image, only one of the vertical and horizontal poles may be reversed.

Rotation of the radar image is recreated by rotating coordinates of the matched filter (that is, matched filter is generated with rotated coordinates).

Enlargement of the radar image is recreated by reducing the size of the matched filter. Specifically, when the size of the matched filter is decreased, relatively, a radar image with an enlarged object in size is generated. Here, the size of the matched filter corresponds to a range of imaging generating the radar image by the synthetic aperture process.

Reduction of the radar image is recreated by enlarging the size of the matched filter. Specifically, when the size of the matched filter is enlarged, relatively, a radar image with a reduced object in size is generated.

In the present embodiment, a second radar image which is different from a first radar image can be generated by changing setting of the matched filter (coordinates, size, and the like) as conditions in the execution of the above-described synthetic aperture process.

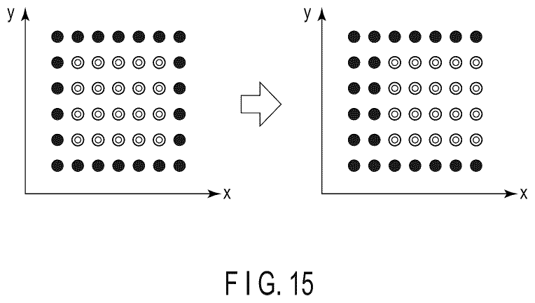

Note that, shifting of the radar image can be recreated by selecting antennas (combination thereof) shifting observation points where observation signals used for generating the radar image are observed as in FIG. 15.

Specifically, a case where a first radar image is generated using observation signals observed at observation points realized by antennas arranged in a range of −10 to +10 cm in direction X will be assumed, for example. In that case, assuming that an object exists in a position where x=±0 cm, the object becomes visible in the proximity of the center of the first radar image. In contrast, assuming that a second radar image is generated using observation signals observed at observation points realized by antennas arranged in a range of ±0 to +10 cm in direction X, in the second radar image, an object becomes visible in a left side of the first radar image. Specifically, assuming that the second radar image is generated using observation signals observed at observation points realized by antennas arranged in a range of −10 to +10 cm in direction X, in the second radar image, an object becomes visible in a right side of the first radar image.

That is, in the present embodiment, a second radar image in which a first radar image (object included therein) is shifted may be generated by changing observation signals (that is, observation points or antennas realizing the observation points) to be targeted in the synthetic aperture process as the condition in the execution of the synthetic aperture process.

In this example, changing setting of the matched filter has been explained, and as described above, a distance to generate a high resolution image is set in the matched filter. If a distance set in the matched filter is shifted, SNR of a radar image generated by execution of the synthetic aperture process (that is, generated using the matched filter) is deteriorated. Specifically, assuming that the synthetic aperture process using the matched filter with setting of a distance 2.5 m is executed while a distance to an object is 2 m, calculated correlation becomes smaller as compared to a case where the matched filter with 2 m distance setting (that is, a radar image with deteriorated SNR is generated).

Thus, in the present embodiment, setting (distance) of the matched filter may be changed in order to deteriorate SNR as above (for example, to add noise).

Furthermore, mixing of the radar image is recreated by generating a synthetic signal sₘᵢₓ from an observation signal s₁ acquired from the radar device 20 and an observation signal s₂ which is different from the observation signal s₁, and executing the synthetic aperture process using the synthetic signal sₘᵢₓ.

That is, in the present embodiment, a second radar image which is different from a first radar image can be generated by executing the synthetic aperture process based on the condition targeting a synthetic signal sₘᵢₓ. In that case, for example, while one object is visible in the first radar image, the second radar image in which two objects including the object and an object which is different from the object are visible (that is, second radar image including object visible by observation signal s₁, and object visible by observation signal s₂) can be generated.

In this example, recreation of an augmentation technique including noise addition, brightness/contrast adjustment, shifting, reversal, enlargement, reduction, and mixing in a radar image achieved by changing conditions at the time of execution of the synthetic aperture process has been explained. However, a second radar image may be generated by recreating a different augmentation technique in a radar image. Hereinafter, smoothing and high resolution will be explained as examples of different augmentation techniques.

First, smoothing of a radar image is recreated by changing resolution of the matched filter. Specifically, resolution of the radar image depends on the resolution of the matched filter (pixel number in one inch), and thus, by changing the resolution of the matched filter when the synthetic aperture process (digital signal process) is executed, a second radar image with higher resolution than that of a first radar image (that is, a smoothed second radar image) can be generated.

For example, if the matched filter in which pixels are arranged at 1 cm intervals to image a range of −10 to +10 cm in directions x and y, the number of pixels of the matched filter is 21×21. On the other hand, if the matched filter in which pixels are arranged at 2 mm intervals to image a range of −10 to +10 cm in directions x and y, the number of pixels of the matched filter is 101×101.

According to the above, by changing the matched filter in which pixels are arranged at 1 cm intervals to the matched filter in which pixels are arranged at 2 mm intervals, a second radar image which is smoothed than a first radar image can be generated.

Now, the high resolution of the radar image can be recreated by changing a combination of antennas realizing observation points where observation signals used in the synthetic aperture are realized (that is, antennas used for the synthetic aperture process). Here, spatial resolution which can be realized in a radar image generated by executing the synthetic aperture process is defined by an aperture length of virtual antennas as above. The aperture length of the virtual antenna corresponds to a distance between antennas positioned at both ends of the antennas used in the synthetic aperture process.

In that case, by changing a combination of antennas used in the synthetic aperture process as the aperture length of the virtual antenna changes, a second radar image with spatial resolution which is different from that of a first radar image can be generated.

For example, assuming that a first radar image is generated using observation signals observed at observation points realized by antennas arranged in in a range of −10 to +10 cm in direction X, an aperture length of the virtual antenna is 20 cm. On the other hand, assuming that a second radar image is generated using observation signals observed at observation points realized by antennas arranged in in a range of −5 to +5 cm in direction X, an aperture length of the virtual antenna is 10 cm.

According to the above, by changing a combination of antennas arranged in a range of −10 to +10 cm in direction X to a combination of antennas arranged in a range of −5 to +5 cm in direction X, a second radar image with spatial resolution lower than that of a first radar image can be generated.

Note that, by changing a combination of antennas arranged in a range of −5 to +5 cm in direction X to a combination of antennas arranged in a range of −10 to +10 cm in direction X, a second radar image with spatial resolution higher than that of a first radar image may be generated.

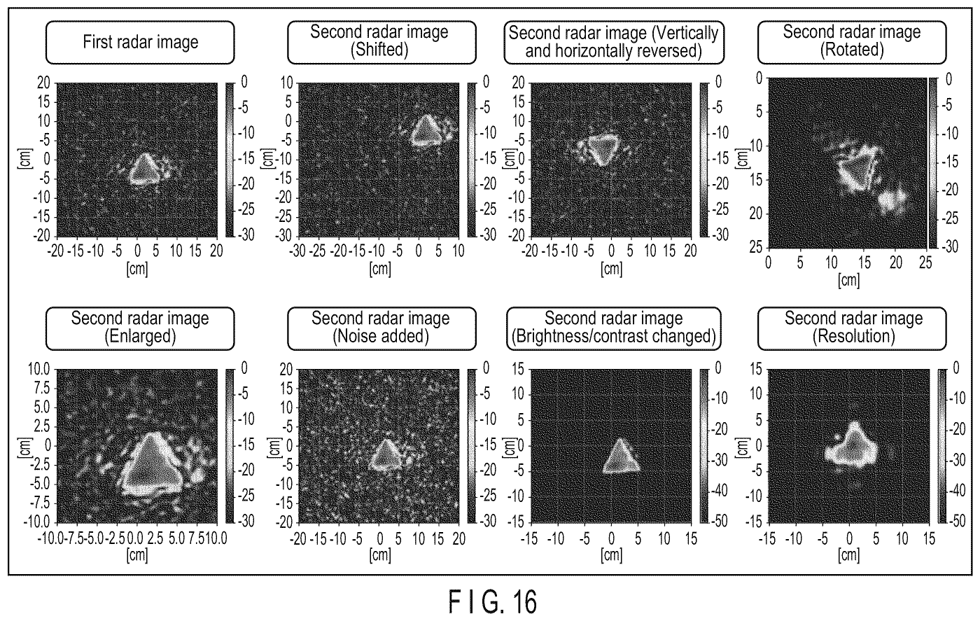

FIG. 16 illustrates examples of first and second radar images generated in the present embodiment. In FIG. 16, examples of a first radar image, second radar image which is the first radar image shifted, second radar image which is the first radar image vertically and horizontally reversed, second radar image which is the first radar image rotated, second radar image which is the first radar image with an enlarged object, second radar image which is the first radar image with noise added, second radar image which is the first radar image with changed brightness and contrast, and second radar image which is the first radar image with changed resolution.

Referring to FIG. 8 again, the training data generation module 341 included in the learning processing module 34 generates training data based on a first radar image generated by executing the synthetic aperture process in step S2 above and a second radar image generated by label information acquired in step S3 and executing the synthetic aperture process in step S7 (step S8). In step S8, a plurality of training data including a combination of radar images (each of first and second radar images) and label information are generated. The training data generated in step S8 are stored in the training data storage 342.

The learning module 343 executes a process of commanding the machine learning model retained in the machine learning model storage 31 to learn training data stored in the training data storage 342 (step S9).

Note that, in the learning of the machine learning model, for example, a process of acquiring label information output from a machine learning model by inputting a radar image included in the training data to the machine learning model, and of performing feedback of a difference between the acquired label information and label information included in the training data (that is, changing parameters such as weighting factor of the machine learning model to decrease the difference) is executed per training data. As described above, the machine learning model which has learnt the training data is again retained in the machine learning model storage 31.

Note that, in FIG. 8, it is assumed that processes of steps S1 to S9 are executed when observation signals are output from the radar device 20; however, the processes of steps S1 to S9 are repeatedly executed each time when observation signals are output from the radar device 20. Thereby, the large amount of datasets can be learnt in the machine learning model, and a machine learning model with high detection accuracy can be obtained.

Furthermore, in FIG. 8, it has been explained that the processes of steps S2 and S3 are executed in the signal processing module 32 after the execution of the process of step S1, and the processes of steps S4 to S7 are executed in the augmentation processing module 33; however, the processes of steps S2 and S3 and the processes of steps S4 to S7 may be executed in parallel, or may be executed in a predetermined order.

Furthermore, in FIG. 8, it has been explained that the training data are generated using the label information acquired in step S3, and if the detection accuracy of the machine learning model is not sufficient, for example, label information output from the machine learning model to which a first radar image is input (label information representing an object included in the first radar image) may not be suitable, and with training data generated using such label information, it is highly possible suitable learning cannot be performed. In that case, in step S3, label information designated (input) by a user using the information processing apparatus 30, for example, may be acquired.

Furthermore, it has been explained that the process of step S9 is executed after the process of step S8 is executed in step 8; however, the process of step S9 may be executed in an optional time.

Specifically, the process of step S9 may be executed at a time when a predetermined number (amount) of training data are stored in the training data storage 342 after the processes of steps S1 to S8 are executed repeatedly, or may be executed at an instruction from a user using the information processing apparatus 30.

Furthermore, if the machine learning model is actually operated for detecting an object included in the radar image, for example, detection accuracy of the machine learning model may be decreased when the object or an environment in which the object is placed changes; however, the process of step S9 above may be executed at a time when the detection accuracy of the machine learning model is determined to be lowered. Specifically, if a machine learning model is configured to output label information and a score (value indicative of credibility of the label information) with respect to the label information, whether or not detection accuracy of machine learning model is lowered can be determined based on the score. Furthermore, if a radar image including a known object can be prepared, whether or not detection accuracy of machine learning model is lowered may be determined based on accuracy rate and the like calculated by comparing label information output from a machine learning model by inputting the radar image to the machine learning model and the known object (label information representing thereof).

An information processing apparatus 30 of the aforementioned embodiment acquires, from a radar device 20 including a plurality of antennas (transmitter antenna 1 and receiver antenna 2) configured to transmit a radar signal and to receive radar echo based on reflective wave of the radar signal, observation signals (first observation signals) based on the radar signal and the radar echo. The information processing apparatus 30 of the embodiment generates a first radar image by executing a synthetic aperture process (radar signal process) based on a first condition predetermined with respect to the observation signal acquired from the radar device 20. Furthermore, the information processing apparatus 30 of the embodiment generates a second radar image by executing the synthetic aperture process (radar signal process) based on a second condition which is different from the first condition with respect to the observation signal obtained from the radar device 20. The first and second radar images generated in the embodiment are used as training data learnt by the machine learning model to detect an object to which the radar signal is transmitted.

In the present embodiment, with the above-described configuration, a second radar image corresponding to an augmented radar image can further be generated from an observation signal by which one radar image (first radar image) alone is generated in general, and thus, training data (radar image) used in the learning of the machine learning model can easily be prepared.

Note that, in the present embodiment, the above-described first and second conditions include, for example, a target of execution of the synthetic aperture process (observation signal) and a matched filter (setting thereof) used when first and second radar images are generated.

Specifically, the first radar image is generated using observation signal acquired from the radar device 20, and the second radar image is generated using synthetic signal (third observation signal) generated by adding an observation signal (second observation signal) which is different from the observation signal to the observation signal. With such a configuration, apart from the first radar image, a second radar image including an object included in the first radar image and an object which is different from the object can be prepared.

Furthermore, the first radar image is generated using the observation signal acquired form the radar device 20, and the second radar image is generated using the observation signal (second observation signal) which is a part of the observation signal. With such a configuration, apart from the first radar image, the second radar image which is the first radar image with deteriorated SNR (that is, first radar image with noise added) can be prepared as training data. Note that, the observation signal which is a part of the observation signal acquired from the radar device 20 corresponds to the observation signal observed at observation points realized by some antennas selected from a plurality of antennas, for example. Furthermore, in this example, it has been explained that the second radar image is a radar image which is the first radar image with deteriorated SNR; however, the second radar image may be a radar image which is the first radar image with improved SNR.

Furthermore, the first radar image is generated by executing the synthetic aperture process to calculate convolution integral of observation signal acquired from the radar device 20 and a first matched filer preliminarily prepared, and the second radar image is generated by executing the synthetic aperture process to calculate convolution of the observation signal and a second matched filter which is different from the first matched filter. With such a configuration, apart from the first radar image, for example, a second radar image which is the first radar image shifted, reversed, rotated, enlarged, or reduced can be prepared.

Note that, when generating a second radar image which is a first radar image shifted, reversed, rotated, enlarged, or reduced described as above, the second matched filter generated by shifting, reversing, rotating, enlarging, or reducing the first matched filter used when the first radar image is generated is used, and the second radar image may be generated using the second matched filter with a distance set therein, which is different from a distance set with respect to the first matched filter, for example. As above, if the second matched filter with a distance set therein, which is different from a distance set with respect to the first matched filter is used, a second radar image which is a first radar image with deteriorated SNR can be prepared as training data, for example.

Furthermore, a second radar image may be generated using a second matched filter having resolution which is different from that of the first matched filter. According to the above, a second radar image having resolution which is different from the resolution of the first radar image can be prepared as training data.

In this example, it has been explained that the first and second conditions include a target of the synthetic aperture process and matched filter (setting thereof), and the first and second conditions may include dynamic range. Specifically, if a first radar image is generated based on a first dynamic range, a second radar image may be generated based on a second dynamic range which is different from the first dynamic range. With such a configuration, a second radar image having brightness and contrast changed from those of the first radar image can be prepared as training data.

Furthermore, in the present embodiment, it is possible to improve detection accuracy of the machine learning model using the first and second radar images generated as above as training data (that is, through the machine learning model learning the training data), and the training data include the first and second radar images and label information representing an object included in the first radar image.

As above, the label information included in the training data may be label information output from a machine learning model by inputting a first radar image to the machine learning model. With such a configuration, for example, a work load of a user preparing label information can be reduced. On the other hand, label information included in the training data may be designated by a user using the information processing apparatus 30. With such a configuration, a case where a machine learning model learns training data including unsuitable label information and thus improvement of detection accuracy of the machine learning model is blocked can be avoided.

Note that, a radar signal in the present embodiment has been explained as to be transmitted based on an FMCW method; however, may be transmitted through a different method. Furthermore, in the present embodiment, a MIMO radar including a plurality of transmitter antennas 1 and a plurality of receiver antennas 2 has been explained as the radar device 20; however, a radar device 20 (radar system) may be realized using various types of radars.

Furthermore, in the present embodiment, a radar signal process executed for generating a radar image has been explained as a synthetic aperture process (signal processing performed in a synthetic aperture radar); however, the radar signal process is not limited to the synthetic aperture process, and the present embodiment can be applied to various radar imaging processes. Specifically, the radar signal process explained in the present embodiment may be a signal process based on beamforming. For example, in a signal process based on beamforming, mode vector is used instead of matched filter for convolution integral, and in that case, augmentation of radar images can be realized by changing conditions of the mode vector.

Furthermore, in the present embodiment, it has been explained that the radar system 10 includes the radar device 20 and the information processing apparatus 30 as in FIG. 6; however, the radar system 10 may be configured differently. Specifically, the radar system 10 may incorporate some of the components 31 to 34 of the information processing apparatus 30 in the radar device 20, and the radar device 20 and the information processing apparatus 30 may be configured integrally. Furthermore, some of the components 31 to 34 included in the information processing apparatus 30 (for example, learning processing module 34 and the like) may be arranged in a server device outside the radar system 10. In that case, process results by the learning processing module 34 arranged in a server device (machine learning model which has learnt training data or parameters of the machine learning model) may be returned to the information processing apparatus 30. Furthermore, the information processing apparatus 30 of the embodiment may be configured to operate various server devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

(1)

An information processing apparatus including a processor configured to:
acquire a first observation signal from a radar device with a plurality of antennas configured to transmit a radar signal and to receive a radar echo based on a reflected wave of the radar signal, the first observation signal being based on the radar signal and the radar echo;
generate a first radar image by executing a signal process based on a predetermined first condition, with respect to the first observation signal; and
generate a second radar image by executing a signal process based on a second condition which is different from the first condition, with respect to the first observation signal, wherein
the first and second radar images are used as training data for a machine learning model to detect an object to which the radar signal is transmitted.

(2)

The information processing apparatus of (1), wherein
the first radar image is generated using the first observation signal, and
the second radar image is generated using a third observation signal generated by adding a second observation signal which is different from the first observation signal to the first observation signal.

(3)

The information processing apparatus of (1) or (2), wherein
the first radar image is generated using the first observation signal, and
the second radar image is generated using a second observation signal which is a part of the first observation signal.

(4)

The information processing apparatus of any one of (1) to (3), wherein
the first radar image is generated by executing a synthetic aperture process by which convolution integral of the first observation signal and a predetermined first matched filter is calculated, and
the second radar image is generated by a synthetic aperture process by which convolution integral of the first observation signal and a second matched filter which is different from the first matched filter.

(5)

The information processing apparatus of (4), wherein the second matched filter is generated by shifting, reversing, rotating, enlarging, or reducing the first matched filter.

(6)

The information processing apparatus of (4) or (5), wherein a distance set with respect to the second matched filter is different from a distance set with respect to the first matched filter.

(7)

The information processing apparatus of any one of (4) to (6), wherein resolution of the second matched filter is different from resolution of the first matched filter.

(8)

The information processing apparatus of any one of (1) to (7), wherein the second radar image is a radar image with a degraded signal to noise ratio of the first radar image.

(9)

The information processing apparatus of any one of (1) to (8), wherein the second radar image is a radar image with a improved signal to noise ratio of the first radar image.

(10)

The information processing apparatus of any one of (1) to (9), wherein
the first radar image is generated based on a first dynamic range, and
the second radar image is generated based on a second dynamic range which is different from the first dynamic range.

(11)

The information processing apparatus of any one of (1) to (10), wherein
the training data includes the first and second radar images, and label information representing an object included in the first radar image output from the learning model by inputting the first radar image to the learning model, or label information representing the object designated by a user.

(12)

The information processing apparatus of any one of (1) to (11), wherein
the radar signal is transmitted based on a frequency modulated continuous wave (FMCW) method.

(13)

A system including:
an information processing apparatus of any one of (1) to (12); and
the radar device.

(14)

A method executed by an information processing apparatus, including:
acquiring a first observation signal from a radar device with a plurality of antennas configured to transmit a radar signal and to receive a radar echo based on a reflected wave of the radar signal, the first observation signal being based on the radar signal and the radar echo;
generating a first radar image by executing a signal process based on a predetermined first condition, with respect to the first observation signal; and
generating a second radar image by executing a signal process based on a second condition which is different from the first condition, with respect to the first observation signal, wherein
the first and second radar images are used as training data for a learning model to detect an object to which the radar signal is transmitted.

(15)

A non-transitory computer-readable storage medium having stored thereon a program which is executed by a computer, the program including instructions capable of causing the computer to execute functions of:
acquiring a first observation signal from a radar device with a plurality of antennas configured to transmit a radar signal and to receive a radar echo based on a reflected wave of the radar signal, the first observation signal being based on the radar signal and the radar echo;
generating a first radar image by executing a signal process based on a predetermined first condition, with respect to the first observation signal; and
generating a second radar image by executing a signal process based on a second condition which is different from the first condition, with respect to the first observation signal, wherein
the first and second radar images are used as training data for a learning model to detect an object to which the radar signal is transmitted.

What is claimed is:

1. An information processing apparatus comprising a processor configured to:
acquire a first observation signal from a radar device with a plurality of antennas configured to transmit a radar signal and to receive a radar echo based on a reflected wave of the radar signal, the first observation signal being based on the radar signal and the radar echo;
generate a first radar image by executing a signal process based on a predetermined first condition, with respect to the first observation signal; and
generate a second radar image by executing a signal process based on a second condition which is different from the first condition, with respect to the first observation signal, wherein
the first and second radar images are used as training data for a learning model to detect an object to which the radar signal is transmitted.

2. The information processing apparatus of claim 1, wherein
the first radar image is generated using the first observation signal, and
the second radar image is generated using a third observation signal generated by adding a second observation signal which is different from the first observation signal to the first observation signal.

3. The information processing apparatus of claim 1, wherein
the first radar image is generated using the first observation signal, and
the second radar image is generated using a second observation signal which is a part of the first observation signal.

4. The information processing apparatus of claim 1, wherein
the first radar image is generated by executing a synthetic aperture process by which convolution integral of the first observation signal and a predetermined first matched filter is calculated, and
the second radar image is generated by a synthetic aperture process by which convolution integral of the first observation signal and a second matched filter which is different from the first matched filter.

5. The information processing apparatus of claim 4, wherein the second matched filter is generated by shifting, reversing, rotating, enlarging, or reducing the first matched filter.

6. The information processing apparatus of claim 4, wherein a distance set with respect to the second matched filter is different from a distance set with respect to the first matched filter.

7. The information processing apparatus of claim 4, wherein resolution of the second matched filter is different from resolution of the first matched filter.

8. The information processing apparatus of claim 1, wherein the second radar image is a radar image with a degraded signal to noise ratio of the first radar image.

9. The information processing apparatus of claim 1, wherein the second radar image is a radar image with a improved signal to noise ratio of the first radar image.

10. The information processing apparatus of claim 1, wherein
the first radar image is generated based on a first dynamic range, and
the second radar image is generated based on a second dynamic range which is different from the first dynamic range.

11. The information processing apparatus of claim 1, wherein
the training data includes the first and second radar images, and label information representing an object included in the first radar image output from the learning model by inputting the first radar image to the learning model, or label information representing the object designated by a user.

12. The information processing apparatus of claim 1, wherein
the radar signal is transmitted based on a frequency modulated continuous wave (FMCW) method.

13. A system comprising:
an information processing apparatus of claim 1; and
the radar device.

14. A method executed by an information processing apparatus, comprising:
acquiring a first observation signal from a radar device with a plurality of antennas configured to transmit a radar signal and to receive a radar echo based on a reflected wave of the radar signal, the first observation signal being based on the radar signal and the radar echo;
generating a first radar image by executing a signal process based on a predetermined first condition, with respect to the first observation signal; and
generating a second radar image by executing a signal process based on a second condition which is different from the first condition, with respect to the first observation signal, wherein
the first and second radar images are used as training data for a learning model to detect an object to which the radar signal is transmitted.

15. A non-transitory computer-readable storage medium having stored thereon a program which is executed by a computer, the program comprising instructions capable of causing the computer to execute functions of:
acquiring a first observation signal from a radar device with a plurality of antennas configured to transmit a radar signal and to receive a radar echo based on a reflected wave of the radar signal, the first observation signal being based on the radar signal and the radar echo;
generating a first radar image by executing a signal process based on a predetermined first condition, with respect to the first observation signal; and
generating a second radar image by executing a signal process based on a second condition which is different from the first condition, with respect to the first observation signal, wherein
the first and second radar images are used as training data for a learning model to detect an object to which the radar signal is transmitted.
